(19) United States
(12) Patent Application Publication
(10) Pub. No.: US 2017/0335678 A1
(43) Pub. Date: Nov. 23, 2017

(54) SMART FRAC PLUG

(71) Applicant: GAS TECHNOLOGY INSTITUTE, Des Plaines, IL (US)

(72) Inventors: Jordan CIEZOBKA, Addison, IL (US); Debotyam MAITY, Des Plaines, IL (US); Kent PERRY, Schaumburg, IL (US)

(73) Assignee: GAS TECHNOLOGY INSTITUTE, Des Plaines, IL (US)

(21) Appl. No.: 15/600,192

(22) Filed: May 19, 2017

Related U.S. Application Data
(60) Provisional application No. 62/340,268, filed on May 23, 2016.

(51) Int. Cl. E21B 47/10; E21B 43/26; G01V 1/52; E21B 47/06; E21B 33/12; E21B 43/116; E21B 47/00; E21B 49/00

(52) U.S. Cl. CPC E21B 47/10; E21B 47/065; E21B 43/26; E21B 47/06; E21B 33/12; G01V 1/52; E21B 47/0002; E21B 49/00; E21B 43/116; G01V 2210/1234; G01V 2210/1429

(57) ABSTRACT

A smart frac plug assembly including an instrument plug module with a sensor for collecting data during a hydraulic fracturing process. This assembly when used in conjunction with a wireless or tubing conveyed data logger and other related recording/processing systems, provides direct measurements of pressure, temperature, observed velocity field and/or observed acceleration field in a subsurface.

### CROSS REFERENCE TO RELATED APPLICATION

This application claims the benefit of U.S. Provisional Patent Application, Ser. No. 62/340,268, filed on 23 May 2016. The co-pending Provisional Application is hereby incorporated by reference herein in its entirety and is made a part hereof, including but not limited to those portions which specifically appear hereinafter.

### BACKGROUND OF THE INVENTION

### Field of the Invention

This invention relates generally to a system and method for collecting data downhole during the hydraulic fracturing process.

### Discussion of Related Art

During a traditional hydraulic fracturing operation a section of the wellbore is stimulated, or hydraulically fractured. The fracturing fluid travels through the wellbore, then through the open set of perforations and then into the hydrocarbon bearing gas shale, thus creating hydraulic fractures.

Traditionally, methods used to acquire downhole pressure and temperature data include behind-the-pipe fiber optic cables, bottom hole pressure gages in vertical wells, and live annuli surface measurements. Technology is not readily available to capture this information, as it is either prohibitively expensive or inadequate in the current horizontal well environment.

### SUMMARY OF THE INVENTION

The subject invention comprises a system for collecting data during a hydraulic fracturing process. This system includes a smart frac plug assembly, which when used in conjunction with a wired, wireless or tubing/casing conveyed data logger and other related recording/processing systems, provides direct measurements of pressure, temperature, and/or any observed velocity and/or acceleration field in a subsurface. The smart frac plug assembly is preferably used with a frac ball sized to block the flow passage in the fracturing plug in order to isolate a previously fractured section of the wellbore. The system of this invention can be also used to determine if the frac ball is making a non-optimized seal with the smart frac plug.

The smart frac plug of this invention preferably includes an instrument plug module comprising one or more units, depending on whether the smart frac plug is being used to measure pressure, temperature, observed velocity and/or acceleration fields and/or any other measurement. Any velocity and/or acceleration field could be associated with elastic waveforms emanating from induced microseismic emissions typically associated with fluid injection operations.

In an embodiment of this invention, the smart frac plug comprises a fracturing plug, also known as a frac plug, having a tubular body and a flow passage, the fracturing plug capable of at least partially isolating a section of a well bore. The smart frac plug of this invention further includes an instrument plug module connected to the fracturing plug, wherein the instrument plug module includes one or more sensors for measuring data during hydraulic fracturing of a wellbore. In a preferred embodiment, the instrument plug module comprises an annular shape which fits on top of an elongated tubular body member housing other components of the smart frac plug of this invention. Alternatively, the instrument plug module may be comprise any shape to be positioned at other locations along the plug. The instrument plug module is capable of measuring different types of data including, but not limited to, pressure, temperature, and/or a velocity and/or acceleration field. The sensors may include a geophone, a MEMS Pressure/Temperature (P/T) sensor, and/or a MEMS accelerometer. An expanding array of geophone/accelerometers will allow progressively better imaging of the hydraulic fracturing process in a pad scale development. However, the system of this invention is not limited to these types of sensors. The instrument plug module preferably also includes a data transmission system for transmitting the measured data to a data logger or another device for recording the measured data. In a preferred embodiment, the data transmission system includes at least one of a transmitter and a receiver, as well as a power source.

During the hydraulic fracturing process, active sources will be used to send elastic waves down into the wells and these waves will be recorded by the sensors. In a preferred embodiment, the sources will be located within a well pad. This process will be repeated for each hydraulic fracturing stage or multiple times during each stage. The data measured by the sensor will be extracted preferably using the data logger and will be processed to provide a near real time, possibly with hours of lag time, image of how the fractured reservoir changes from one stage to the next. Providing diagnostic information with respect to fracturing efficiency and issues.

### BRIEF DESCRIPTION OF THE DRAWINGS

These and other objects and features of this invention will be better understood from the following detailed description taken in conjunction with the following drawings.

FIG. 1A is a schematic diagram showing the plug and perf hydraulic fracturing process showing a fracked stage.

FIG. 1B is a schematic diagram showing the plug and perf hydraulic fracturing process with perforation assembly and plug placement.

FIG. 1C is a schematic diagram showing the plug and perf hydraulic fracturing process with running perforations.

FIG. 1D is a schematic diagram showing the plug and perf hydraulic fracturing process with proppant pumping for fracturing.

FIG. 2 is a partial sectional side view of a known prior art frac plug.

FIG. 3 is a sectional side view of a smart frac plug according to an embodiment of this invention showing placement of an instrument plug module.

FIG. 4A is a schematic diagram of the instrument plug module according to an embodiment of this invention showing a design with three oriented geophones to measure 3 axis movement along with pressure/temperature monitoring sensor, power source and electronics package. AA′ is a ring element axis.

FIG. 4B is a schematic diagram of the instrument plug module according to another embodiment of this invention showing tri-axial MEMS accelerometer to measure 3 axis acceleration along with pressure/temperature monitoring sensor, power source and electronics package. AA′ is the ring element axis.

FIG. 5 is schematic drawings of a geophone.

FIG. 6 is a schematic diagram of a MEMS single axis accelerometer.

FIG. 7A is a graph of geophone gather and a graph of accelerometer gather.

FIG. 7B is a graph showing amplitude spectra for geophones as solid lines and showing amplitude spectra for accelerometer as dashed lines.

FIG. 8 is a schematic diagram showing wireless data transmission of the smart frac plug of this invention and a data logger.

FIG. 9 is a schematic diagram showing passive seismic monitoring using the smart frac plug of this invention.

FIG. 10 is a schematic diagram showing 3D active seismic monitoring using the smart frac plug of this invention.

FIG. 11A is a schematic diagram of the instrument plug module showing transmitter/receiver antennae placement for radio frequency communication according to an embodiment of this invention.

FIG. 11B is a schematic diagram of the instrument plug module showing transmitter/receiver antennae placement for communication along a casing according to an embodiment of this invention.

FIG. 12 shows a graph of a transmitted bit stream and received signal for a buried pipe.

### DETAILED DESCRIPTION

As detailed below, the invention of this application is a device for measuring and collecting data during a hydraulic fracturing process including, but not limited to, temperature, pressure, and/or a velocity and/or acceleration field.

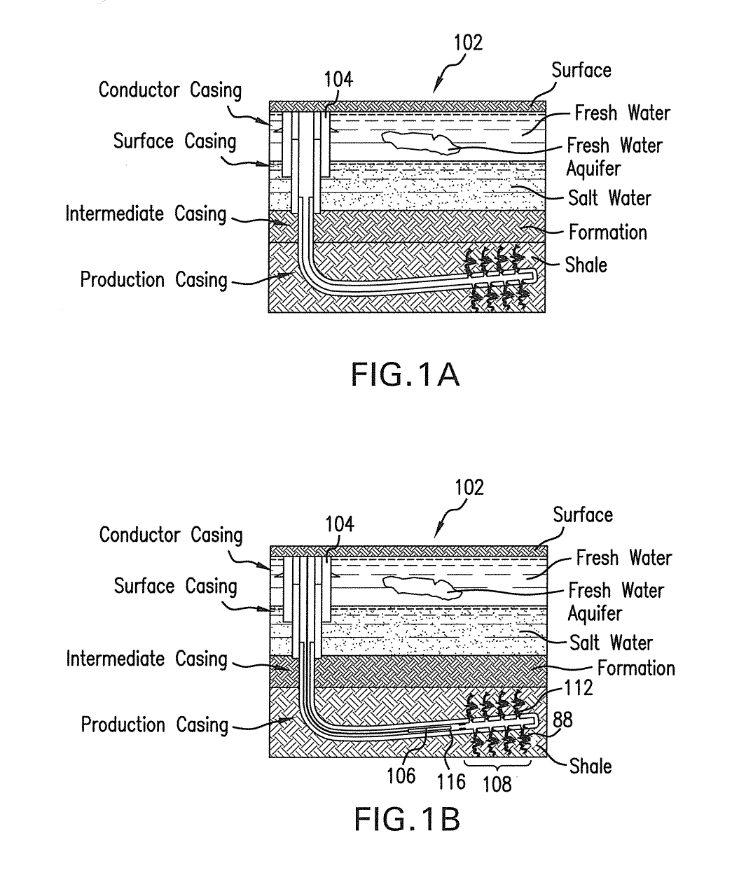

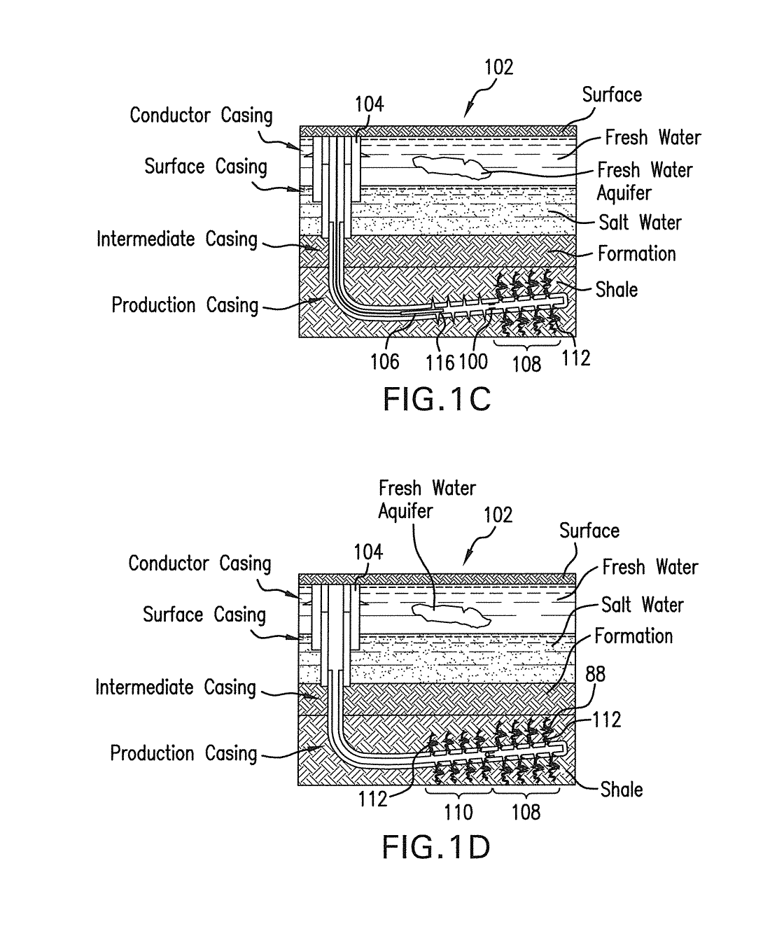

FIGS. 1A-D illustrate a typical “plug & perf” fracturing process and generally involves a large number of fracture stages that are hydraulically isolated during each stage using a traditional isolation frac plug 100. In operation, once a well 102 has been drilled and a production casing 104 has been cemented, the fracking process can begin. The broad steps involved are as follows. After a well toe or first stage 108 has been fractured, a perforating assembly 106 with an attached isolation frac plug 100 is positioned downhole from a next zone or second stage 110 to be stimulated. The isolation frac plug 100 includes a flow passage 34 and is set to at least partially block flow further down the well in order to isolate the next zone 110 to be fractured from prior fractured stages 108. Charges within the perforating assembly 106, equipped with shaped charge, are activated to perforate casing/cement/rock mass interval which is to be hydraulically fractured. Next a frac ball 32 is pumped down the well and set on a frac ball seat on the isolation frac plug 100 set to block the flow passage 34 and hydraulically isolate the previously completed stage, the first stage 108, with the new stage, the second stage 110, which is to be pumped. Once perforations 112 have been created in the second stage 110, the perforating assembly 106 is removed from the well 102 and a wellhead connected with pump trucks, not shown, in order to inject proppant and fracturing fluid into the new stage 110. Preferably, this process is repeated until all of the stages have been hydraulically fractured 88. These traditional frac plugs 100 are not capable of measuring and collecting data during the fracturing process. The claimed invention leverages the location of the fracturing plugs and the tools in place to acquire valuable data which can help improve our understanding of the hydraulic fracturing process as well as the reservoir behavior during and post stimulation.

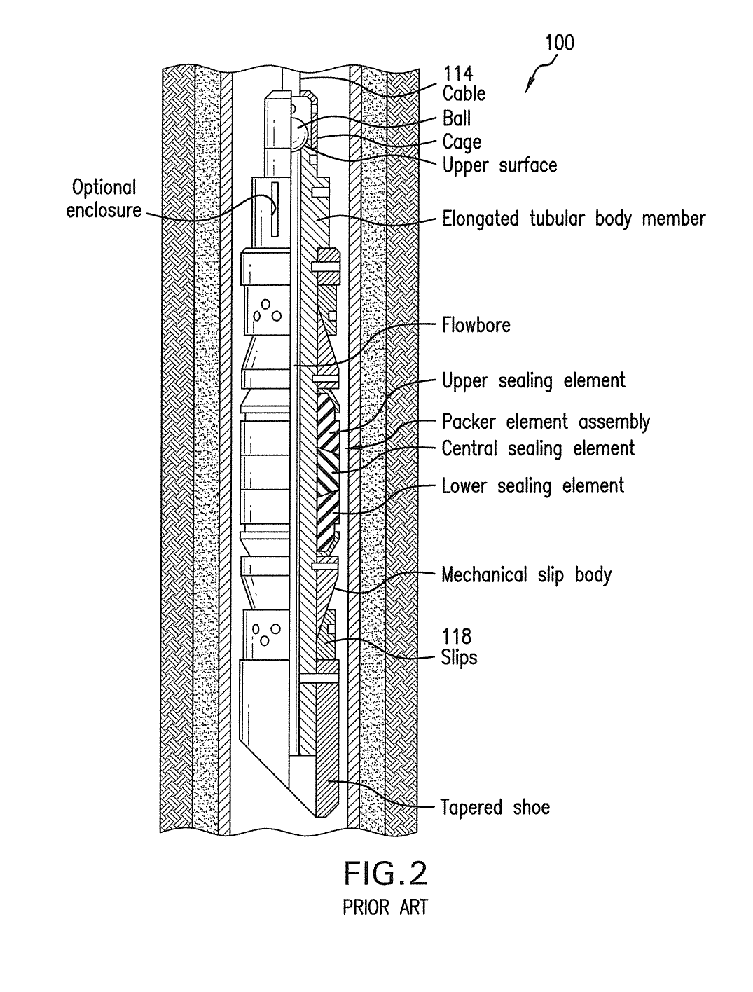

FIG. 2 shows a schematic of a typical known frac plug 100 used in hydraulic fracturing. In operation, fluid is pumped into the well 102 to hydraulically push wireline with the plug 100 and the perforating assembly/gun 106 to isolate the previous stage or the first (well toe) stage 108. An electrical signal is sent via a cable 114 to activate a setting tool 116 which activates slips 118 to bite thinly to the inner casing 104 and push sealing elements 120 firmly against the casing 104 to create hydraulic isolation across the plug 100. The slips 118 preferably include multifaceted polymer elements which compress to create a seal. The setting tool then shears off the plug that has been set, perforating guns are activated by sending electrical signals through the cable.

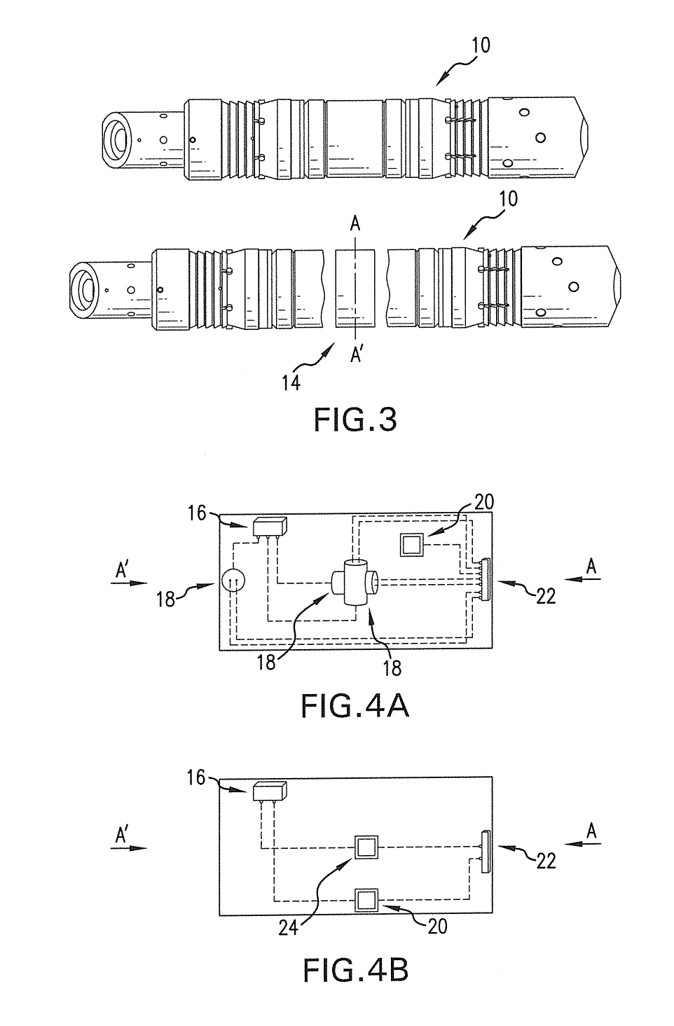

FIG. 3 illustrates a novel smart frac plug assembly 10 according to one embodiment of this invention, which when used in conjunction with a wireline or tubing conveyed data logger 12 and/or other related recording/processing systems, provides direct measurements of pressure, temperature as well as any observed velocity and/or acceleration field in a subsurface. Any velocity and/or acceleration field could be associated with elastic waveforms emanating from induced microseismic emissions typically associated with fluid injection operations. The smart frac plug 10 of this invention will be similar in design to the traditional frac plug 100 and will include many similar components but will include an instrument plug module 14 which may comprise a single unit or multiple units depending on which and how many hydraulic fracturing characteristics are to be measured. In preferred embodiments, each of the instrument plug modules 14 will be ring shaped and couple with an elongated tubular body of the smart frac plug 10. FIG. 3 shows a schematic of the frac plug 10 illustrating placement of the instrument plug module 14 along a sealing element, according to one embodiment of this invention. Please note that it is possible to place the instrument plug module 14 at other locations along the plug 10 as well. Alternatively, the instrument plug module 14 may comprise another shape and may be positioned at another location on the smart frac plug 10.

In an embodiment of this invention, the pressure and/or temperature measurement may provide a real time trigger for the data logger 12 and/or other recording/processing system to begin collecting data. For example, when there is an abrupt change in pressure or temperature across the plug 10, this indicates a possible change in flow conditions (no flow to hydraulic fracturing initiation) and as a result, the controller triggers the data logger 12 to start logging measurements for later use. This embodiment saves power and/or storage requirements of the system. Alternatively, the logging of data may be triggered by a modulated signal down the wellbore as vibrations in the steel casing or by a pressure pulse through the well. The system of this invention may also be triggered to record data using RF transmission. Another possible embodiment, the data logger 12 continuously logs data without a triggering mechanism.

FIGS. 4A and 4B each show a schematic representation of the instrument plug module 14 according to embodiments of this invention. Each embodiment shows different components and sensors that may be included in the instrument plug module 14. FIG. 4A shows an embodiment of the instrument plug module 14 including a power source 16 connected to a plurality of oriented geophones 18 to measure 3-axis movement, a pressure/temperature monitoring sensor (MEMS P/T senor) 20, and an electronics package 22. The electronics package 22 may include, but is not limited to, a microprocessor and/or a controller for the instrument plug module 14. FIG. 4B shows an alternative embodiment including a tri-axial MEMS accelerometer 24 to measure 3-axis acceleration along with pressure/temperature monitoring sensor 20, power source 16 and the electronics package 22. Note AA′ is the ring element axis shown in FIG. 3. Other possible embodiments of the instrument plug module 14 are possible by redistributing the sensors depending on engineering or other requirements. Alternative embodiments of the instrument plug module 14 may utilize other types of sensors.

The smart frac plug 10 of this invention, in addition to the sensors, may further include a data transmission system including, for example, transmitters 26 and/or receivers 28. Depending on various options with respect to instrumentation, the instrument plug design can vary. Two possible alternative designs are described in connection with FIG. 4 however other designs are possible. The smart frac plug 10 of this invention can be used for various applications ranging from gathering pressure and temperature data along all of the laterals during completion of stages and wells associated with a particular well pad. Some of the identified applications are as follows:
1) Pressure and temperature measurements during treatment along stages of an offset well can help understand fluid communication between two well laterals. This in turn can help understand the fracturing process in general and specific issues associated with completions (such as stress shadowing, fluid channeling and bypass, etc.). Pressure data can also help identify potential fluid loss to prior frac stages.
2) Since the plugs will remain in place until the plugs are drilled out before the wells are finally brought into production, the smart plug 10 can be used to measure early flowback characteristics.
3) Changes in the velocity and/or acceleration field due to propagating elastic waves can help identify source characteristics of induced seismic events from within the stimulated reservoir. This can help map the zone impacted by the injected fluid and proppant and help with completion diagnostics. This invention can also help understand the prevailing stress conditions within the stimulated rock mass.
4) Using active sources at the surface, limited seismic imaging can be carried out by moving the source on the surface to various locations and collecting the associated seismic data from smart frac plugs. With proper survey design, it should be possible to image the stimulated reservoir which in turn can help understand changes that may have occurred as a result of fluid injection during hydraulic fracturing.
5) Since the perforations are created using controlled explosion of shaped charges in the cemented wellbore, after the first well of the pad is completed, both the compressional and shear wave velocity models can be improved by tying the perforations with the seismic waveforms observed at the smart frac plugs.
6) During hydraulic fracturing process, active sources will be used to send elastic waves down the earth to the completion wells and these waves will be recorded by the sensors, geophones/accelerometers. More preferably, the source will be located in a well within the pad being completed. This process will be preferably repeated for each hydraulic fracturing stage or multiple times during the stage. The data will be extracted using the data logger and will be processed to provide a near real time image of how the fractured reservoir changes from one stage to the next. This will provide real time diagnostic information with respect to fracturing efficiency and issues. In alternative embodiments, the data will be processes with some lag time possibly hours of lag time.
7) During hydraulic fracturing, micro-earthquakes occur due to high pressure fluid breaking down the rock in the reservoir. This creates small induced earthquakes which release energy which is measured by the array of smart frac plugs of this invention. Using various techniques, such as passive imaging, the location of these earthquakes as well as the properties of the rock can be identified. This analysis may be done at the end of each stage or multiple times during each stage being hydraulically fractured.
8) In case of reservoirs where there are multiple plays, the system of this invention uses sensors in each those plays. Allowing for sensors to be distributed with reasonable vertical offset, for example hundreds of feet of offset, which will allow better delineation of micro-earthquake locations in case of passive imaging or better imaging of the subsurface in case of active imaging.
9) Based on velocity and/or acceleration measurements in the early period, effective communication of perforated interval with the wellbore can be established. The same can be done with pressure and temperature measurements.

Another property that can be potentially recorded and utilized is electrical resistivity. Changes in electrical resistivity with time can be used in conjunction with the pressure or temperature data to understand fluid compositional changes at or near the corresponding smart frac plug location.

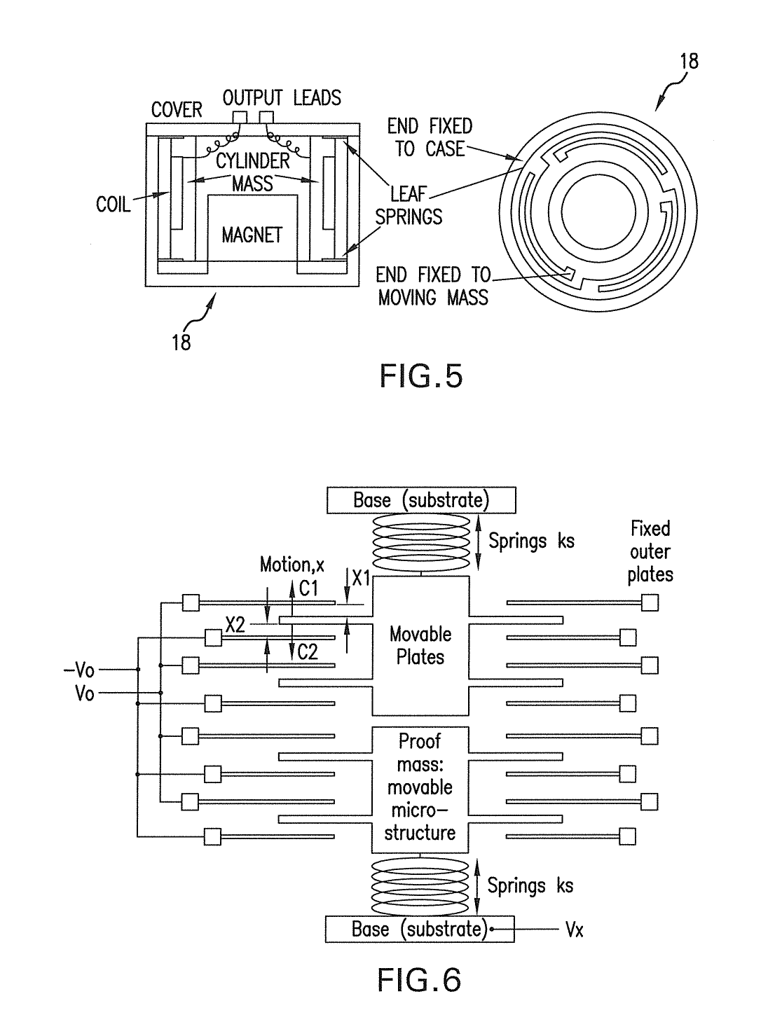

The geophones 18, as described above in the instrument plug module 14, are devices used to measure ground motion. In earthquake seismology, oriented geophones are used in combination to provide information regarding distance and direction of elastic waveforms that are transmitted through the subsurface and are recorded at the geophones as the waveform crosses the sensor. FIG. 5 shows both a schematic and a cross sectional view of one type of moving coil electromagnetic geophone 18, specifically a moving coil exploration type 4.5 Hz geophone. This geophone is one type of geophone that may be used with the instrument plug module and it should be understood that other types of geophones may be used. The geophone includes a permanent magnet is in a cylindrical form with a circular slot. The slot separates an annular N pole from a central S pole. A coil comprising a very fine conductor wire is suspended in the slot with the help of leaf springs. When the sensor moves along the central axis, the magnet moves with it but the coil tends to stay fixed due to inertia. The relative motion between the coil and the magnetic field produces a voltage between the coil terminals.

A common capacitive type MEMS accelerometer shows very high sensitivity and accuracy at high temperatures. FIG. 6 shows schematic of a typical MEMS single axis accelerometer. If two plates are kept parallel separated by some distance, capacitance can be defined based on permittivity of a separating material, area of an electrode and a separating distance. Change in the capacitance measured from baseline can be used to measure acceleration which causes a change in the separating distance between the plates. A movable microstructure, or proof mass, is connected to a mechanical suspension system and consists of the movable capacitor plates. Additional capacitors added at 90° to one another are used to create the 3-axis accelerometer 24.

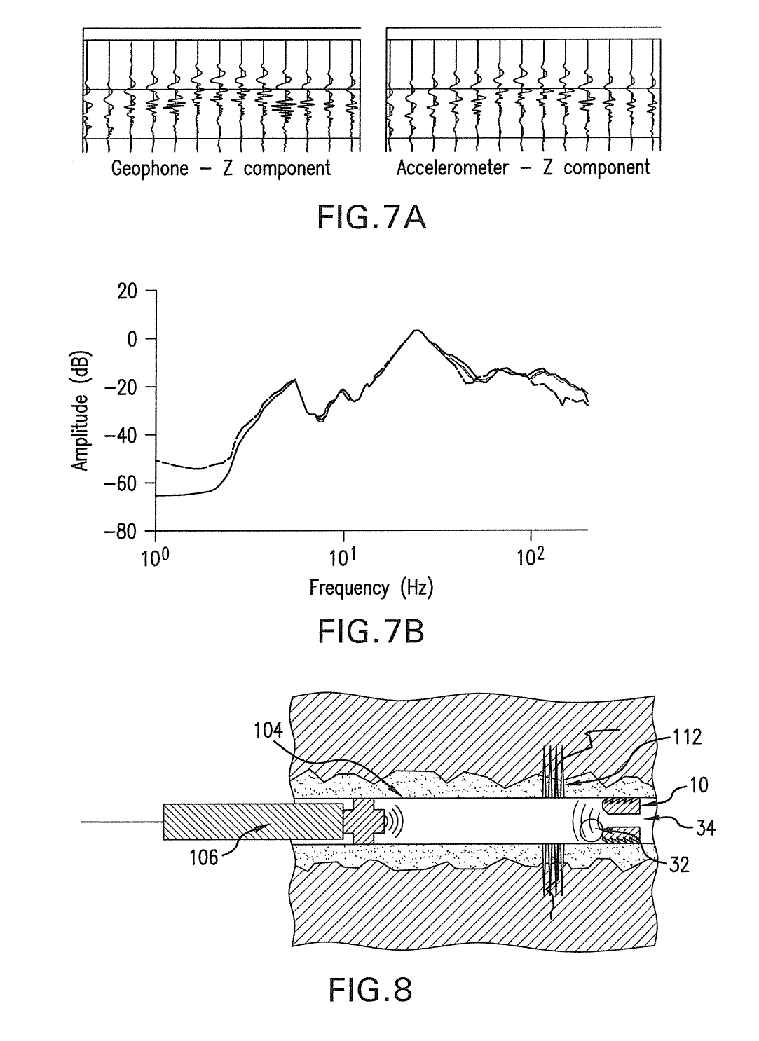

The utility of accelerometers in traditional seismic monitoring or imaging activities have been studied over the past few years. Recent results indicate applicability under most conditions to be considered. The only issues involves re-scaling of data in order to match observations from traditional geophones in case geophones are also involved in monitoring/imaging activities as explained in a later section. FIG. 7A shows a sample comparison between waveforms recorded in a 3D reflection seismic survey between geophones and MEMS accelerometer, geophone gather on left and accelerometer gather on right. FIG. 7B shows comparison between amplitude spectra of the two systems at a particular receiver location highlighting potential usability, amplitude spectra for geophones shown as solid lines and amplitude spectra for accelerometer shown as a dashed line.

3D seismic imaging involves understanding the wave traversal characteristics of direct, reflected (most common), refracted or mode converted waves as the waves travel through the subsurface strata between carefully placed sources (such as dynamite, vibrators, etc.) and receivers (geophones). As the waves travel through the subsurface, the waves undergo perturbations (wave propagation phenomenon) which depends on the subsurface rock characteristics (impedance contrasts, fractures & faults, layered structures, salt bodies, etc.). The changes to the waveform can be recorded at the receivers and can be interpreted to understand what the subsurface looks like both structurally as well as stratigraphically.

The main difference between seismic imaging using active sources (using active sources placed at other wells or on the surface, such as a vibrator truck) and passive seismic monitoring is the absence of any active source. In passive seismic monitoring, the sources are either naturally occurring (such as earthquakes and micro-earthquakes) or induced (such as seismicity associated with fluid injection). When there is a change in the stress state within a rock, we observe failure within the rock due to either slippage on existing faults or creation of new fractures. Since the failure is elastic in nature, the failure is accompanied by seismic waves which propagate out from the point of failure. Passive seismic monitoring involves triangulating these failures and evaluating other source characteristics such as magnitude of seismic event and its moment.

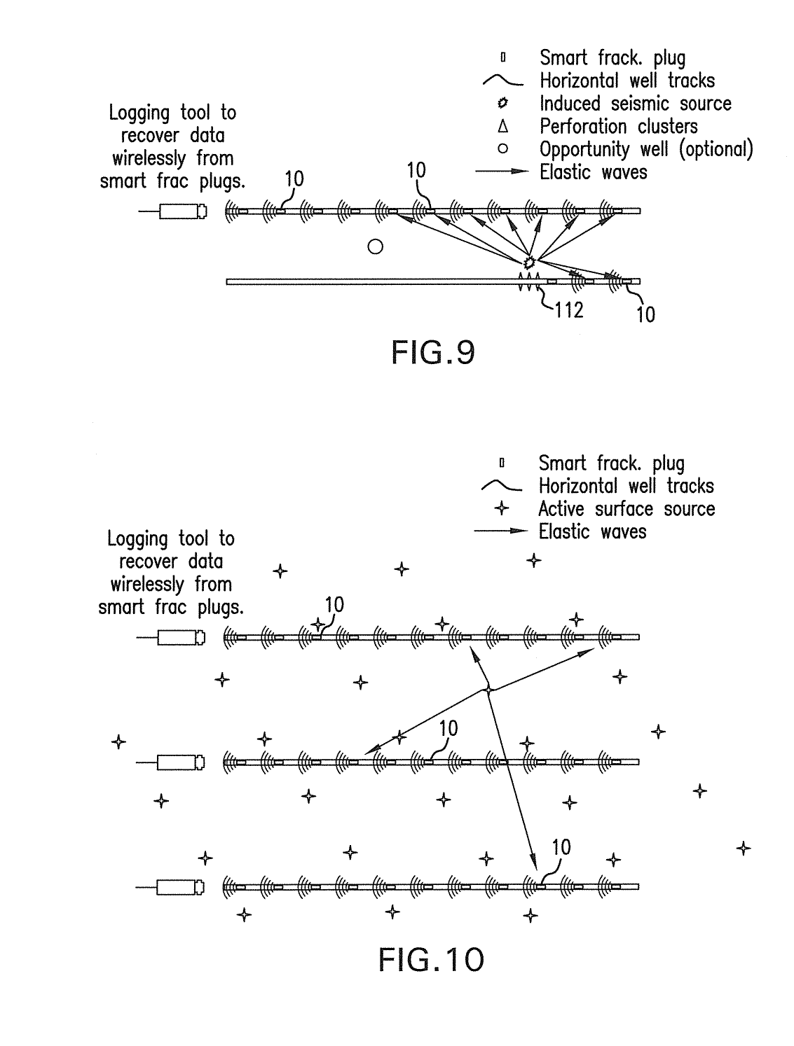

The system of this invention may use various methods for data retrieval. In a preferred embodiment shown in FIG. 8, the data logger 12 can be sent downhole at the end of each completion to retrieve relevant data from a smart frac plug daisy chain sequence 30. In another embodiment of data retrieval shown in FIG. 9, the data logger 12 can be sent downhole once all of the frac stages have been completed and all of the data collected during the hydraulic fracturing process can be retrieved at one go. It might be preferable to use the first embodiment highlighted here since the logger can be a part of the perforation assembly and therefore, will lead to faster data retrieval. All of the data collected is wirelessly transmitted through the smart frac plug daisy chain 30 and recovered using the data recovery logging tool 12. For those frac plugs 10 that are downstream of the stage being completed, towards the toe of the said wellbore, the data is stored and the recovery happens after the entire well has been fracked. Data processing and analysis can either happen in near real time (using the data collected from offset well) or post completion after recover of data from all available smart frac plugs. The optional opportunity well shown is a vertical well available in the vicinity of the wellbore laterals being hydraulically fractured and these wells can also be used for monitoring by placing tri-axial geophones close to the depths of interest. For other possible embodiments, the opportunity well could be horizontal laterals (instead of verticals), highly deviated, and more than a one.

FIG. 10 shows another potential deployment and data recovery scheme associated with 3D seismic imaging of the reservoir above the wells being hydraulically fractured. Please note, unlike a traditional 3D reflection seismic survey, the system of this invention will be looking at direct as well as indirect and converted arrivals for imaging. While this can be carried out during fracking operations, FIG. 10 depict operations once the entire well pad has been completed, all wells have been hydraulically fractured but the plugs are yet to be drilled out. As the source, for example a vibrator truck, is moved to various locations highlighted in the diagram, the elastic waves emanating from the particular source travels through the earth till it is recorded by the sensors in the smart frac plug 10. The recorded data gets wirelessly transmitted through the series of smart frac plugs 10 to be collected by the data logger 12 and then processed as required.

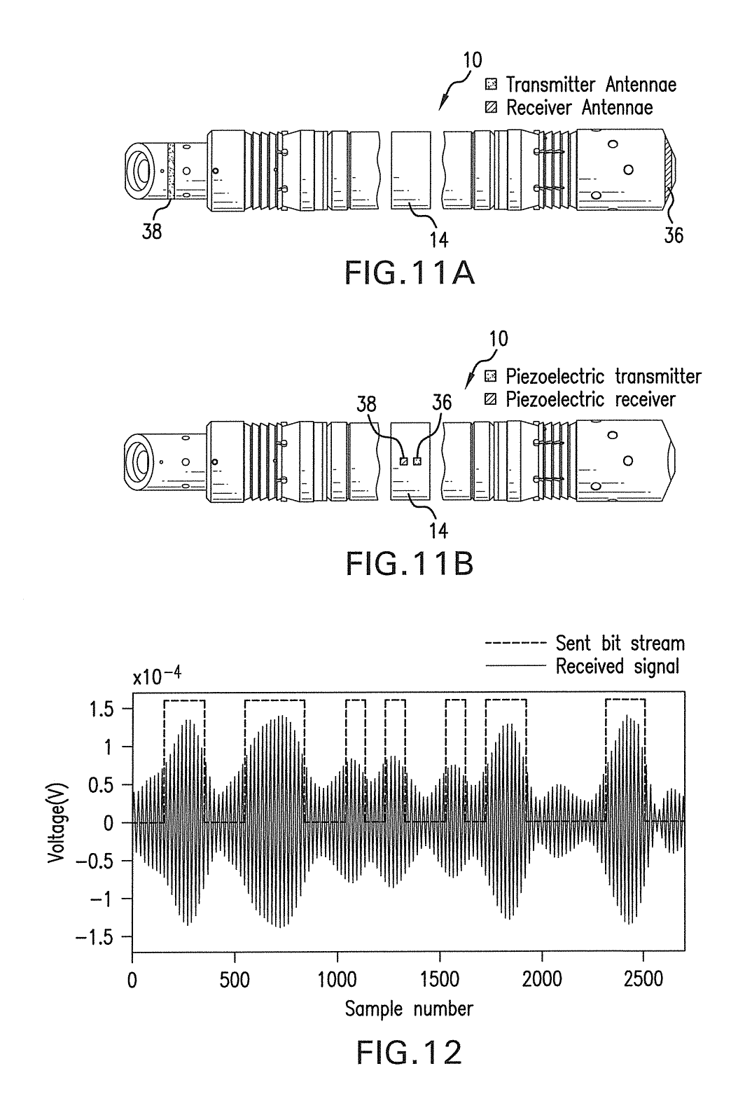

In a preferred embodiment of this invention, the smart frac plugs 10 will be “daisy-chained” together to form a data transmission network, the system has to be both robust as well as wireless to operate in deep lateral wells. Most portable systems for radio frequency based data transmission typically work in the very high frequency (VHF) through ultra-high frequency (UHF) bands. However, due to highly dense matter in the earth's crust, radio waves cannot travel very far due to high degree of attenuation and scatter. Since the frequency has to be significantly low, antennae size needs to be relatively large. As such, in a preferred embodiment, the frac plug 10 includes a receiver antennae 36 and a transmitter antennae 38 embedded into the smart frac plug 10 as conductive radial rings at opposite ends of the plug 10. FIG. 11A shows an example of potential transmitter/receiver 36, 38 placement schemes along smart frac plug 10 for RF communication. Alternatively, radio frequency signals may be transmitted through the wellbore fluid. In this embodiment, the system of this invention may make use of the cemented steel pipe casing 104 as a data transmission conduit. In this case, the transmitter antennae 36 and the receiver antennae 38 may be piezoelectric and can be placed within the packer plug assembly as that would allow good contact between the unit and the casing. FIG. 11B shows an embodiment of the smart frac plug 10 of this invention for communication along the casing 104.

The data transmission workflow for each hydraulic fracturing site could first involve some ambient noise recording at receivers and gathering said data for analysis of noise characteristics. This could be done during periods between completions through a single run of the data extraction logging tool. Ambient noise characteristics are important to understand because they will have a significant impact on the quality and interpretation of the transmitted data. Another important test is to do frequency sweep analysis to identify peak signal frequency. This can be done in more controlled settings and optimal values can be identified beforehand so that the system can be calibrated in advance. Finally signal modulation can be controlled based on noise characteristics for bitwise data transfer between all of the smart frac plug pairs. Some recent experimental work shows that such transmission can be potentially possible up to distances of a few hundred meters. FIG. 12 shows an example of transmitted bit stream and received signal for a buried pipe. Specifically, FIG. 12 shows a band-pass filtered, 500 Hz AM-modulated signal. The transmitter-receiver separation in this case was 130 feet. Before transmission, the data will have to be modulated (Amplitude Modulation) and based tests will have to be done to access the attenuation characteristics of the wellbore. The signals received at the receiver of the next smart frac plug will have to be sampled at adequately high frequency to satisfy Nyquist criterion.

In an embodiment of this invention, the smart plugs could be retrieved and deployed on future wells.

Thus, the invention provides a smart frac plug assembly for collecting data during a hydraulic fracturing process. This system when used in conjunction with a wireline or tubing conveyed data logger and other related recording/processing systems, provides direct measurements of pressure, temperature, and/or any observed velocity and/or acceleration field in a subsurface.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

1. A device for collecting data during a hydraulic fracturing process, the device comprising:
a frac plug including an instrument plug module, wherein the instrument plug module includes a sensor for measuring data comprising at least one of pressure, temperature, a velocity field, and an acceleration field during hydraulic fracturing.

2. The device of claim 1, further comprising a data logger for recording measured data.

3. The device of claim 2, further comprising a controller, wherein when the sensor detects a change in one of pressure or temperature, the controller signals to the data logger to start or stop measuring data of the velocity field or the acceleration field.

4. The device of claim 2, wherein the instrument plug module further includes a data transmission system including at least one of a transmitter and a receiver to transmit measured data between the instrument plug module and the data logger.

5. The device of claim 1, wherein the instrument plug module includes at least one of a geophone, a MEMS Pressure/Temperature sensor, a single axis MEMS accelerometer.

6. The device of claim 1, wherein the instrument plug module includes three orientated geophones to measure three axis movement.

7. The device of claim 1, wherein the instrument plug module includes a tri-axial MEMS accelerometer to measure three axis acceleration.

8. A system for collecting data during a hydraulic fracturing process, the system comprising:
a plurality of frac plugs connected in sequence, each frac plug including an instrument plug module, wherein the instrument plug module includes a sensor for measuring data comprising at least one of pressure, temperature, a velocity field, or an acceleration field during hydraulic fracturing.

9. The system of claim 8, further including a data logger for recording measured data.

10. A system for collecting data during a hydraulic fracturing process, the device comprising:
a smart frac plug comprising:
a fracturing plug comprising a tubular body and a flow passage, the fracturing plug capable of at least partially isolating a section of a well bore;
an instrument plug module connected to the fracturing plug, wherein the instrument plug module includes one or more sensors for measuring data including at least one of pressure, temperature, a velocity field, and an acceleration field during hydraulic fracturing;
a frac ball comprising a spherical shape and large enough to block the flow passage in the fracturing plug;
a data logger for recording the measured data.

11-15. (canceled)

16. The method of claim 25, further comprising a step of transmitting measured data from the instrument plug module to a data logger.

17. The method of claim 16, wherein the step of transmitting measured data from the instrument plug module to the data logger includes using multiple smart plugs to transmit the measured data as a daisy chain sequence.

18. The method of claim 25, wherein the instrument plug module includes at least one of a geophone, a MEMS Pressure/Temperature sensor, a single axis MEMS accelerometer.

19. The method of claim 25, wherein the instrument plug module includes three orientated geophones to measure three axis movement.

20. The device of claim 25, wherein the instrument plug module includes a tri-axial MEMS accelerometer to measure three axis acceleration.

21. The system of claim 10, wherein the instrument plug module further includes a data transmission system including at least one of a transmitter and a receiver to transmit data between the instrument plug module and the data logger.

22. The system of claim 10, wherein the instrument plug module includes at least one of a geophone, a MEMS Pressure/Temperature sensor, a single axis MEMS accelerometer.

23. The system of claim 10, further including a controller, wherein when one of the sensors detect either a pressure change or a temperature change, the controller instructs the data logger to start recording at least one of the velocity field or the acceleration field.

24. The system of claim 10, wherein multiple smart plugs are used to transmit the measured data in a daisy chain sequence.

25. A method of isolating a section of a wellbore and monitoring physical parameters of the wellbore during hydraulic fracturing, the method comprising:
setting a smart frac plug along a length of the wellbore, wherein the smart frac plug includes an instrument plug module for measuring data comprising at least one of pressure, temperature, a velocity field, or an acceleration field, and wherein the smart frac plug sealingly engages a wall of the wellbore and includes an flow passage extending through the frac plug;
sealing the flow passage with a frac ball;
fracturing a section of the well bore; and
measuring data comprising at least one of pressure, temperature, velocity fields, and acceleration fields with the instrument plug module.
